(19) United States
(12) Patent Application Publication
(10) Pub. No.: US 2009/0063850 A1
(43) Pub. Date: Mar. 5, 2009

(54) MULTIPLE FACTOR USER AUTHENTICATION SYSTEM

(76) Inventors: Sharwan Kumar Joram, Pune (IN); Grzegorz Pelechaty, Wolow (PL); Pawan Kumar Chauhan, Pune (IN); Srikanth Vittal, Vijayawada (IN)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/846,965

(22) Filed: Aug. 29, 2007

(51) Int. Cl. H04L 9/32

(52) U.S. Cl. 713/155

(57) ABSTRACT

The present invention describes a method and a system for multi-level authentication of a user and a server. The user registration process in the invention enables user to personalize the web page of the server. Further, the user authentication takes place in a multi-step process including entering credentials such as user ID, subset of user's password, subset of shared secret and a One Time Password (OTP). The system of the present invention provides various means of entering the said credentials which prevents phishing attacks.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates generally to authentication systems. More specifically it relates to a method and system for verifying the authenticity of entities in a network and authorizing it for further transactions.

Authentication of entity is very important while performing various transactions either online or in person. It is important to verify the identity of the individuals and organizations while dealing with them. Various system exist performing authentication of various entities. However these are prone to a variety of security breaches in form of phishing.

‘Phishing’ is a fast growing online theft. It is a theft of identity. Phishing is a form of fraud that aims to steal valuable information such as credit card details, social security number, user id, passwords, financial details etc. Phishers attempt to fraudulently acquire sensitive information by masquerading as a trustworthy entity in an electronic communication. Phishing is an attack that combines social engineering, web spoofing and often spamming in an attempt to trick users out of confidential information for a variety of nefarious reasons.

There are an ever increasing number of ways to attack a customer using phishing attacks.

Observing Customer Data—In this class of attack, key-loggers and screen-grabbers can be used to observe confidential customer data as it is entered into a web-based application. The purpose of key loggers is to observe and record all key presses by the customer—in particular, when they must enter their authentication information into the web-based application login pages. Some sophisticated Phishing attacks make use of code designed to take a screen shot of data that has been entered into a web-based application.

Man-in-the-middle Attacks—In this class of attack, the attacker situates themselves between the customer and the real web-based application, and proxies all communications between the systems. From this vantage point, the attacker can observe and record all transactions.

Preset Session Attacks—In this class of attack, the phishing message contains a web link to the real application server; it also contains a predefined SessionID field. The attackers system constantly polls the application server for a restricted page (e.g. an e-banking page that allows fund transfers) using the preset SessionID. Until a valid user authenticates against this SessionID, the attacker will receive errors from the web-application server (e.g. 404 File Not Found, 302 Server Redirect, etc.). The phishing attacker must wait until a message recipient follows the link and authenticates themselves using the SessionID. Once authenticated, the application server will allow any connection using the authorized SessionID to access restricted content (since the SessionID is the only state management token in use). Therefore, the attacker can use the preset SessionID to access a restricted page and carryout his attack.

URL Obfuscation Attacks—Using URL obfuscation techniques, the attacker tricks the customer into connecting to their proxy server instead of the real server. This attack is also known as mass attack, wherein a mass e-mail is sent to a number of users. The mass e-mail contains a link to an URL made by the attacker. The said URL represents a replica of an authentic log-in webpage.

Conventional one factor and two factor methods and systems exist in art which try to provide solutions for user authentication. The said methods and systems includes biometric authentication, hardware token based authentication, Standard Static Password Recognition (SSPR) authentication, Virtual Keyboard System etc. Others such as ‘Verisign’ have developed systems employing authentication with the use of digital signatures. However, the existing systems address some but not the all of the existing problems. For example Virtual Keyboard System addresses problem of “Observing Customer Data”, however it fails to address other problems such as man-in-the-middle attack. Further, authentication solutions such as hardware token based authentication, involves the use of hardware tokens that is not economical and is cumbersome to operate. It is also important to validate the server, a user is logging in, to prevent URL obfuscation attack. Thus the need of a system that provides end-to-end solution to authentication and also provides enhanced security against phishing attacks is apparent.

### BRIEF SUMMARY OF THE INVENTION

An object of the present invention is to provide a secure authentication method and system using multi-factor authentication of a user and a server.

Another object of the present invention is to provide a secure method and system for multi-factor authentication of a user and a server that prevents various phishing and hacking attacks such as man-in-the-middle attack, key-logger attack, URL obfuscation attack, mass spamming attack etc.

Yet another object of the present invention is to facilitate user authentication while using different hashing algorithms for data encryption for different sessions.

In accordance with various embodiments of the present invention, a user registers for future transactions on a web page of a server. The registration includes entering a phrase with an associated symbol. In an embodiment such a phrase could be a favorite quote and symbol could be an image or a color. The said phrase is displayed along with the preselected symbol, whenever user enters his/her user ID for authentication.

Further, the present invention involves multi-level authentication system wherein a user is required to enter a subset of his password, a subset of a shared secret through a virtual puzzle and a One Time Password (OTP) using a symbol tray.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram illustrating a network comprising a plurality of users and a server connected via network in which present invention can be implemented, in an embodiment of the present invention.

FIG. 2 is a block diagram illustrating an authentication system in accordance with an embodiment of the present invention.

FIG. 3 is a flow chart illustrating a method for registering an authentic user to be able to access a secure server after authentication in accordance with an embodiment of the present invention.

FIGS. 4a and 4b is a flow chart illustrating a method for authenticating and authorizing a user and a server in accordance with an embodiment of the present invention.

FIG. 5 is a pictorial representation of a virtual keyboard in accordance with an embodiment of the present invention.

FIG. 6 is a pictorial representation of a virtual puzzle in accordance with an embodiment of the present invention.

FIG. 7 is a pictorial representation of a color tray to enter One Time Password (OTP) in accordance with an embodiment of the present invention.

### DETAILED DESCRIPTION OF THE INVENTION

Various embodiments of the invention provide a method and a system for authenticating and authorizing a user and a server connected via a network. In a client/server system, a user by means of a client machine requests the server to access a resource or carry out some transactions. The server in turn serves the request. However, the resources or services should be available to a valid user. Therefore, the user, in order to access the resource from a server needs to be authenticated.

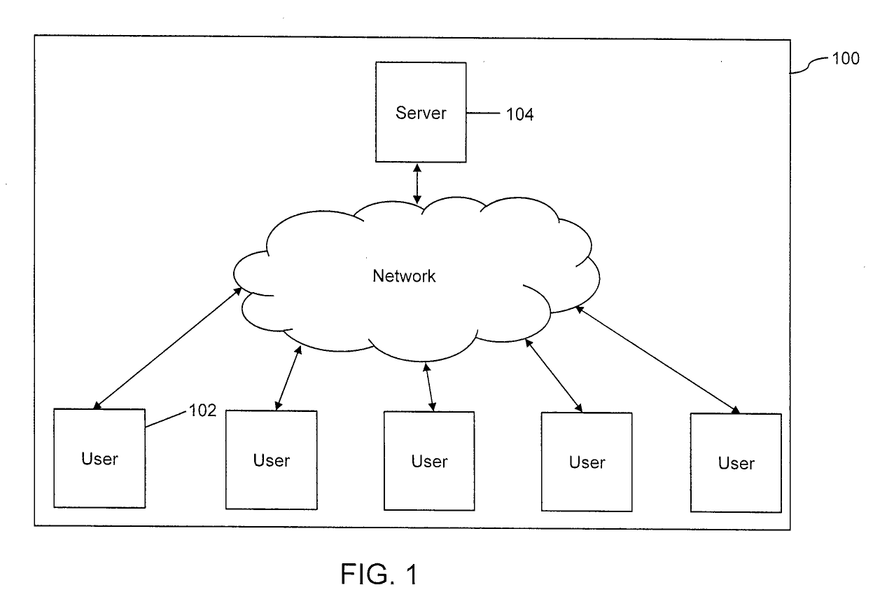

Further, while doing business or financial transactions over Internet, it is important to verify the identity of an individual user or organizations. At the same time, it is important for a user to verify that he is dealing with an authentic server or service provider and not a phisher. The present invention relates to a method and system for verifying the authenticity of the user in a network and authorizing it for further transactions without providing user secrets until a sufficiently high level of assurance of the authenticity of the server is achieved. The various embodiments of the present invention will now be discussed in detail with reference to FIGS. 1-7.

FIG. 1 is a block diagram illustrating a network 100 comprising a plurality of users 102 and a server 104 connected via network 100 in which present invention can be implemented, in an embodiment of the present invention. Examples of network include Local Area Network (LAN), Wide Area Network (WAN), Virtual Private Network (VPN), and Internet. It is well known in the art, there are several protocols for a user 102 at a client device to register with, or logon to, server 104, for example a bank customer login to a bank web site. In accordance with various embodiment of the present invention, user 102 may use a personal computer, a PDA, a cellular telephone, or other telecommunications device in communication, either by a physical line or a wireless connection, to network 100.

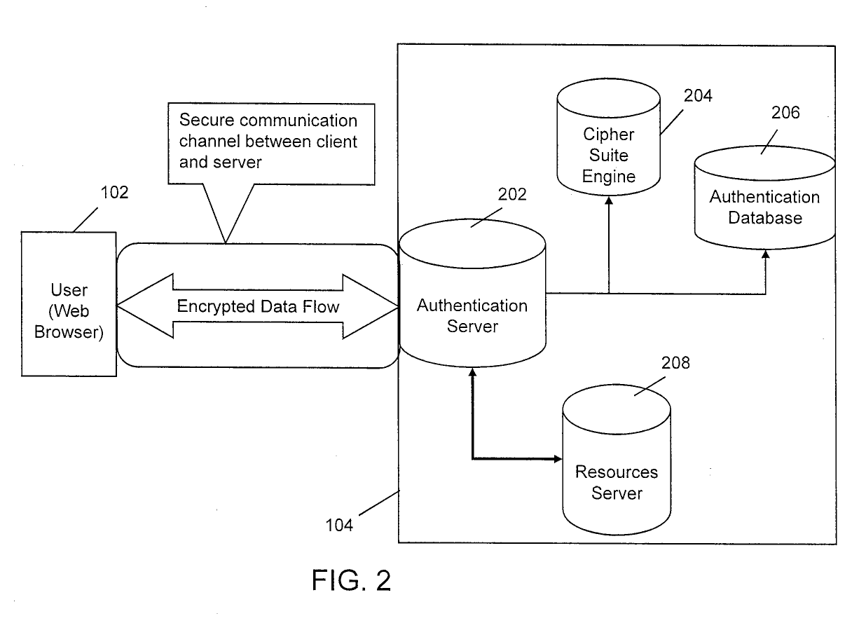

FIG. 2 is a block diagram illustrating a system for authenticating and authorizing a server in accordance with an embodiment of the present invention. User 102 is connected with server 104 via network 100 through a secure communication channel. In accordance with one embodiment of the present invention, the secure communication channel can be SSL (SSL v 3.1). The secure communication channel ensures secure transfer of encrypted data between user 102 and server 104.

Server 104 comprises an authentication server 202, a cipher suite engine 204, an authentication database 206 and a resources server 208. Cipher suite term is used for an array of hashing algorithms. Cipher suite engine 204 comprises one or more hashing algorithms. Examples of hashing algorithms are MD5, MD4, MD2, SHA0, SHA1, SHA-256/224, SHA-512/384, HAVAL, PANAMA, VEST-4/8 and the like. A hashing algorithm or a cipher is an algorithm for performing encryption and decryption. Specifically it is a series of well defined steps that can convert data to a set of encrypted code. The present invention introduces the concept of using a series of hashing algorithm randomly instead of using a single hashing algorithm for encryption. Cipher suite engine 204 randomly selects a particular hashing algorithm from a series of hashing algorithms available, to encrypt the data being transferred between user 102 and server 104.

Authentication database 206 comprises information pertaining to various users. Authentication server 202 verifies various information regarding user 102 from the information stored in authentication database 206. After user 102 is authenticated, authentication server 202 connects user 102 to resources server 208 for further transactions.

In accordance with an alternate embodiment of the present invention, server 104 can further comprise a Short Messaging Services (SMS) gateway engine. SMS gateway engine is used to inform user 102 at his mobile device of various transactions. Further, various one time passwords/challenge codes can also be sent in SMS through SMS gateway engine.

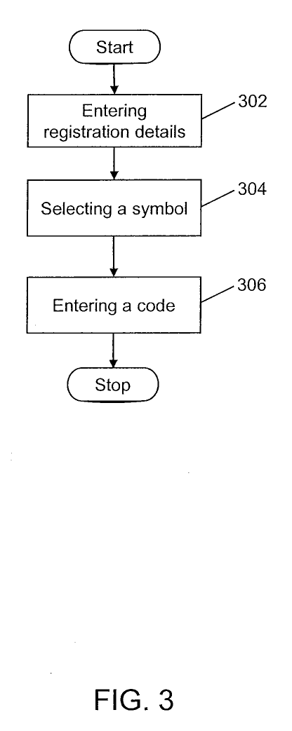

FIG. 3 is a flow chart illustrating a method for registering an authentic user to be able to access a secure server after authentication in accordance with an embodiment of the present invention. User 102 in order to communicate with server 104 and access its resources needs to be registered. User 102 provides information which usually includes characteristics such as name, user ID, age, address, phone number, gender, zip etc.

At step 302, user 102 enters registration details such as name, user ID, age, address, phone number, gender, zip and the like in a registration form. The said registration form can either be submitted online in a web browser or can be submitted personally to the concerned authoritative personnel of server 104. At step 304, user 102 selects a symbol from an array of symbols presented to him. In accordance with an embodiment of the present invention, the symbol can either be an image or a color or a plurality of other graphical representations or a combination of any the symbols. At step 306, user 102 enters a code. In accordance with an embodiment of the present invention, the code entered can be a phrase or a quote. Whenever user 102 enters his/her user ID to log on, the server sends back a web page showing the code along with the symbol. In accordance with another embodiment of the present invention the server sends back the favorite quote entered with a background of the color selected. This particular process of registration helps user 102 to identify the authenticity of the server web page. Further, it prevents a kind of phishing attack known as mass attack or spam attack. In mass attack, a phisher sends mass mails containing a link to a login web page. This login web page is not the original but a replica of the original login web page. Therefore personalizing a web page of server 104 with user 102 favorite quote in selected colour ensures that user 102 is communicating with an authentic server and not a phishing server.

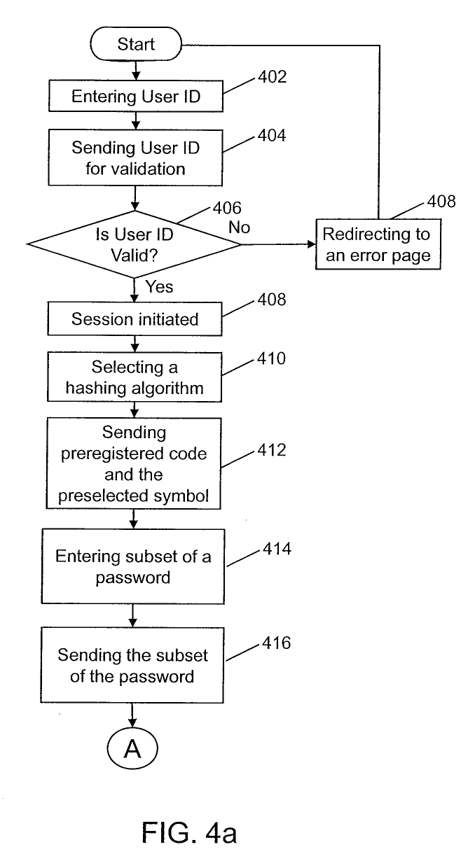

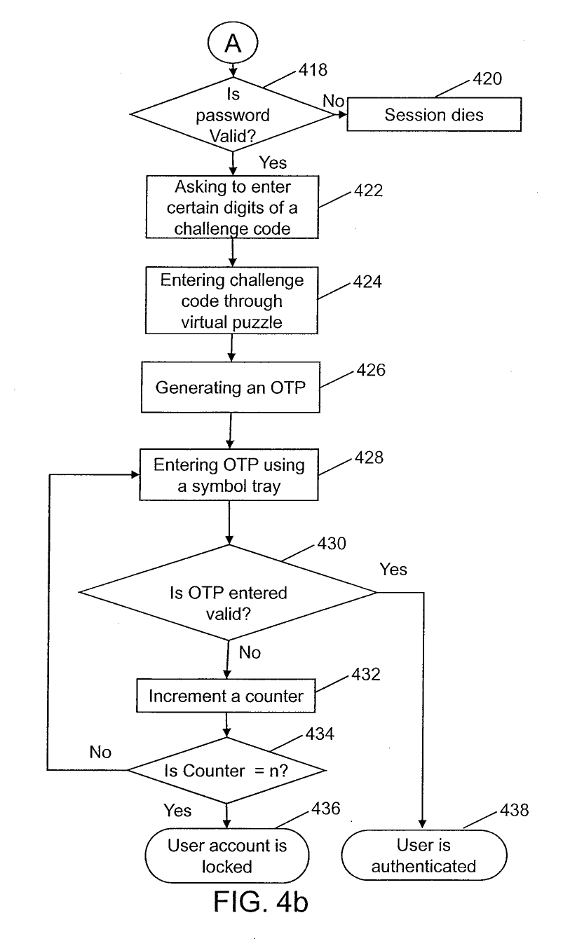

FIGS. 4a and 4b is a flow chart illustrating a method for authenticating a user and a server in accordance with an embodiment of the present invention. At step 402, user 102 enters his/her user ID on a login web page of server 104. At step 404, the login entered is then sent to authentication server 202 for validation. Authentication server 202 verifies if the user ID is valid, at step 406. If the user ID entered is not valid, authentication server 202 informs user 102 that the user ID is invalid and redirects him to an error page, as shown in step 408. If at step 406, user ID entered is valid, a session between user 102 and authentication server 202 is initiated for further authentication, as shown in step 408. As soon as the user ID is validated by authentication server 202 for user 102, user information including his previous history of logins is fetched by authentication server 202 from authentication database 206. Authentication server 202 further checks the hashing algorithm used in the last login.

At step 410, authentication server 202 selects a hashing algorithm randomly from the cipher suite engine. The hashing algorithm selected at step 410 is different from the hashing algorithm used in the previous login attempt. In accordance with an alternate embodiment of the present invention, SMS gateway engine is reported about the validation of user ID. A mobile alert is then sent to the mobile device of user 102 about the validation of user ID. The hashing algorithm selected at step 410 is used for entire session duration of user 102. At step 412, authentication server 202 sends response to user 102 in form of the favorite quote in the color selected by user 102 at the time of registration. The response is sent in the form of a web page, in accordance with an embodiment of the present invention.

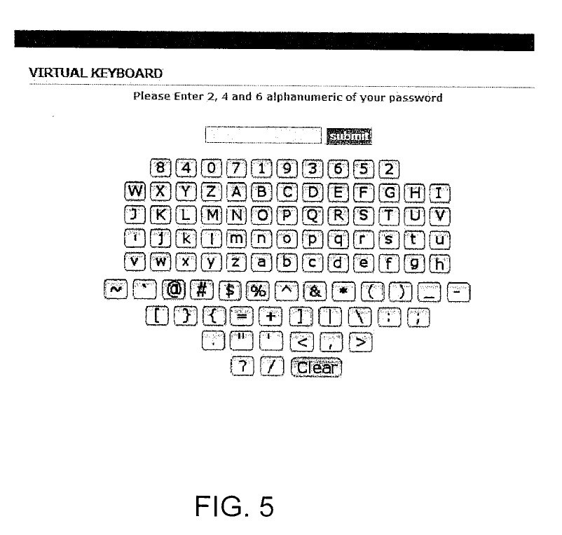

Further in the response web page, user 102 is asked to enter a subset of a password. In accordance with one embodiment of the present invention, 3 random digits of the password are asked to be entered. At step 414, user 102 enters the subset of the password. For example, if the password is “ahs123$”, authentication server 202 might ask user 102 to enter 2^{nd}, 4^{th} and 5^{th} digit of the password sequence. The digit sequence is determined randomly by authentication server 202. The random subset of the password sequence is entered by means of a virtual keyboard displayed on the browser. A virtual keyboard is a replica of a keyboard but is generally operated through a mouse. In accordance with one embodiment of the present invention, the virtual keyboard used in the present invention has keys which arranges randomly after every login attempt. Therefore the random re-arrangement of the keys in the virtual keyboard prevents phishers or hackers to anticipate the position on the virtual screen used to enter a password. FIG. 5 is a pictorial representation of the virtual keyboard in accordance with an embodiment of the present invention.

At step 416, the subset of the password is sent to authentication server 202 for validation. At step 418, authentication server 202 validates the subset of the password entered. If the subset of the password entered is not valid, then at step 420 the session is terminated and user 102 is redirected to an error page. However, if the subset of the password entered is valid, then at step 422, authentication server 202 asks user 102 to enter one or more random digits of a challenge code in a webpage. In an alternate embodiment, the one or more random digits of the challenge code can also be asked through the SMS gateway engine to the mobile device of user 102. In accordance with various embodiments of the present invention, the challenge code can be selected from a group comprising credit card number, debit card number, social security number, personal account number and the like.

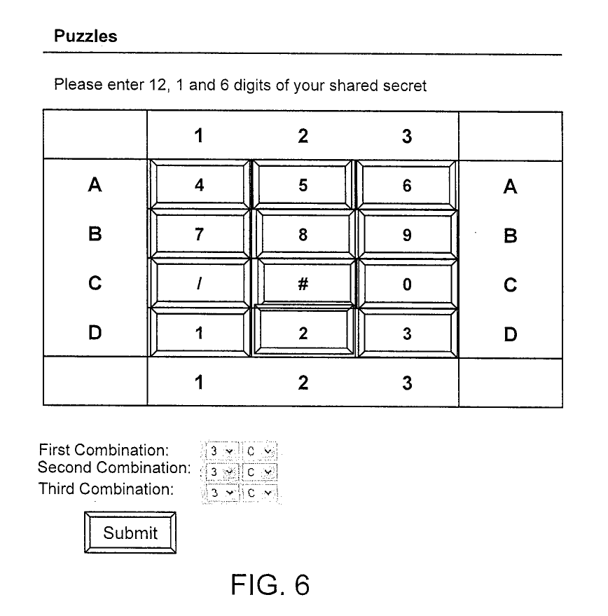

At step 424, challenge code is entered through a virtual puzzle. FIG. 6 is a pictorial representation of the virtual puzzle in accordance with an embodiment of the present invention. Generally, one or more random digits of the challenge code are asked to be entered. The one or more random digits of the challenge code are entered through the virtual puzzle. For example, if the user has to enter 7, 2 and 6, then according to the virtual puzzle shown in FIG. 6, he would select (1,B), (2,D) and (3,A) in the drop down.

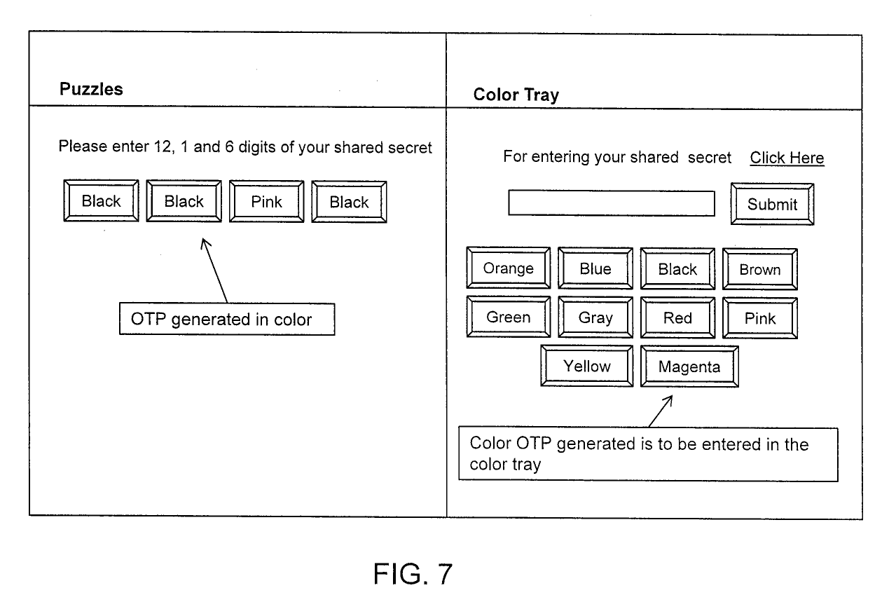

Once the challenge code is entered using the virtual puzzle, then at step 426, a one time password (OTP) is generated. The OTP generated is displayed in the browser in the form of one or more sequence of colors. At step 428, the OTP generated is entered using a color tray as shown in FIG. 7. At step 430, the OTP entered through the color tray is validated by authentication server 202. If the OTP entered is not valid, then at step 432, authentication server 202 increments a counter with it set at zero at the start of a session. The said counter is managed to allow user 102 to re-enter the OTP if the OTP entered is not valid. However, authentication server 202 allows a predetermined number of attempts (n) to enter OTP through the color tray. At step 434, the authentication server checks if the counter is equivalent to n. If the counter is not equivalent to n, authentication server 202 asks user 102 to re-enter the OTP through the colour tray. In case the counter id equivalent to n, then at step 436, user account gets locked. In accordance with one embodiment of the present invention, n is equal to 2. This means user 102 is allowed to make 3 attempts to enter the OTP through the colour tray. If at step 430, the OTP entered is valid, then at step 438, user 102 is authenticated by authentication server 202 to proceed with further transactions and to access resources server 208.

The present invention facilitates multi-factored authentication of a user and a server. The features provided for secure user authentication prevents various phishing attacks which is a serious concern in financial and business transactions over internet. Using a set of hashing algorithms instead of one prevents phisher or attacker to anticipate the encrypted data and steal it. A phisher will never be able to identify which hashing algorithm is being used for a particular session. Further, using the concepts of virtual key board, virtual puzzle and symbol tray will prevent the attack related to observation of customer data, such as key logging, screenshots, and observation of entry of credentials. The present invention ensure secure authentication irrespective of the place and machine a user is logging in. A user can securely login even while being in a public place or through a public computer.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A multi-factor method for authenticating a user and a server, the user being connected to the server through a host device, the method comprising the steps of:
a. entering a user id, the user id being entered by the user in a browser to connect to the server;
b. authenticating the user id and initiating a session for further authentication and authorization, the user id being authenticated by the server;
c. selecting a hashing algorithm, the hashing algorithm being selected by the server;
d. sending one or more preregistered codes, the one or more preregistered codes being send by the server to the user;
e. entering a subset of a password, the subset of the password being entered by the user;
f. validating the subset of the password, the subset of the password being validated by the server;
g. sending a challenge code, the challenge code being sent by the server to the user;
h. generating a One Time Password (OTP), the OTP being generated by entering the challenge code through a virtual puzzle;
i. entering the OTP through a symbol tray, the OTP being entered by the user; and
j. validating the OTP, the OTP being validated by the server.

2. The method according to claim 1, wherein registering the user further involves opting for Short Messaging Services (SMS) functionality, the SMS functionality being opted to send SMS to a user's mobile device at various steps of authentication.

3. The method according to claim 1, wherein the hashing algorithm is selected from a cipher suit.

4. The method according to claim 1, wherein the hashing algorithm is selected to encrypt the data being communicated between the user and the server.

5. The method according to claim 1, wherein the hashing algorithm selected is different for two successive login attempts.

6. The method according to claim 1, wherein the one or more preregistered codes are selected at the time of registration for using a web application, the web application requiring a user authentication.

7. The method according to claim 1, wherein the one or more preregistered codes are selected from a group comprising preregistered phrase, preregistered color, preregistered image, preregistered symbol and the like.

8. The method according to claim 1, wherein the subset of the password being entered comprises three random digits.

9. The method according to claim 1, wherein the subset of the password being entered is different for two successive attempts.

10. The method according to claim 1, wherein the challenge code is a subset of a shared secret, the shared secret being selected from a group comprising magnetic strip card number, social security number, personal account number and the like.

11. The method according to claim 1, wherein the OTP generated is a sequence of symbols, the symbols being selected from a group comprising color, pictorial representation and the like.

12. A system for authenticating a user and a server, the user being connected to the server through a host device, the system comprising:
a. an authenticating server, the authenticating server being connected to a cipher suite engine and a database; and
b. a client module, the client module being connected to the authorizing server via a secure communication channel.

13. The system according to claim 12, wherein the authenticating server can further be connected to a Short Messaging Services (SMS) gateway engine.

14. The system according to claim 12, wherein the client module is a web browser at a user's end.

15. The system according to claim 12, wherein the secure communication channel is a secure https tunnel.

16. The system according to claim 12, wherein the cipher suite engine comprises one or more hashing algorithms used to encrypt data.

17. The system according to claim 12, wherein the cipher suite engine ensures encryption of data with a different hashing algorithm for every consecutive session of data transfer.

18. A computer program product for use with a computer, the computer program product comprising a computer usable medium having a computer program code embodied therein for authenticating a user and a server, the user being connected to the server through a host device, the computer program product facilitating the steps of:
a. entering a user id, the user id being entered by the user in a browser to connect to the server;
b. authenticating the user id and initiating a session for further authentication and authorization, the user id being authenticated by the server;
c. selecting a hashing algorithm, the hashing algorithm being selected by the server;
d. sending one or more preregistered codes, the one or more preregistered codes being send by the server to the user;
e. entering a subset of a password, the subset of the password being entered by the user;
f. validating the subset of the password, the subset of the password being validated by the server;
g. sending a challenge code, the challenge code being sent by the server to the user;
h. generating a One Time Password (OTP), the OTP being generated by entering the challenge code through a virtual puzzle;
i. entering the OTP through a symbol tray, the OTP being entered by the user; and
j. validating the OTP, the OTP being validated by the server.
